(19) United States
(12) Patent Application Publication
(10) Pub. No.: US 2010/0043718 A1
(43) Pub. Date: Feb. 25, 2010

(54) Submerged motor for aquarium

(76) Inventor: Chi-Der Chen, Taipei (TW)

Correspondence Address: PRO-TECHTOR INTERNATIONAL SERVICES, 20775 NORADA CT., SARATOGA, CA, 95070, US

(21) Appl. No.: 12/196,290

(22) Filed: Aug. 22, 2008

(51) Int. Cl. A01K 63/04; F04B 17/04

(52) U.S. Cl. 119/263; 417/410.1

(57) ABSTRACT

A submerged motor for use in an aquarium is disclosed to include a housing one or water input ports and two water output ports, a driving mechanism having a left-sided water pumping device and a right-sided water pumping device for pumping water through the water input ports and the water output port in different directions, and an electric controller electrically connected with the driving mechanism for controlling operation of the left-sided water pumping device and the right-sided water pumping device to change direction and flowing speed of the pumped water.

### BACKGROUND OF THE INVENTION

1. Field of the Invention

The present invention relates to a submerged motor and more particularly, to a submerged motor for use in an aquarium that causes movement of water resembling natural water waves.

2. Description of the Related Art

An aquarium generally has a submerged motor mounted therein for pumping water, causing water to move in the aquarium. A submerged motor for this purpose generally comprises a housing defining a water inlet and a water outlet, and a water pump mounted inside the housing for pumping water into the water outlet and forcing water out of the water outlet. The flowing direction of pumped water is constantly the same, resulting in low oxygen consumption rate that is not optimal for raising fish and other water animals.

Therefore, it is desirable to provide a submerged motor for aquarium that eliminates the aforesaid drawbacks.

### SUMMARY OF THE INVENTION

The present invention has been accomplished under the circumstances in view, it is one object of the present invention to provide a submerged motor for use in an aquarium, which causes movement of water resembling natural water waves, raising oxygen consumption rate.

To achieve this and other objects of the present invention, the submerged motor is for use in an aquarium, comprising a housing one or water input ports and two water output ports, a driving mechanism having a left-sided water pumping device and a right-sided water pumping device for pumping water through the water input ports and the water output port in different directions, and an electric controller electrically connected with the driving mechanism for controlling operation of the left-sided water pumping device and the right-sided water pumping device to change direction and flowing speed of the pumped water.

In one embodiment of the present invention, the left-sided water pumping device and a right-sided water pumping device are water pumps.

In another embodiment of the present invention, the driving mechanism comprises further comprises a magnetic rotor rotatably mounted inside the housing, and a winding mounted inside the housing around the magnetic rotor and controllable by the electric controller to cause rotation of the magnetic rotor in one of two reversed directions. Further, the left-sided water pumping device and a right-sided water pumping device are vanes respectively fastened to the two opposite ends of the magnetic rotor for synchronous rotation.

### BRIEF DESCRIPTION OF THE DRAWINGS

FIG. 1 is a schematic front view of a submerged motor in accordance with a first embodiment of the present invention.

FIG. 2 is a schematic front view of a submerged motor in accordance with a second embodiment of the present invention.

FIG. 3 is a schematic front view of a submerged motor in accordance with a third embodiment of the present invention.

FIG. 4 is a schematic front view of a submerged motor in accordance with a fourth embodiment of the present invention.

FIG. 5 is a schematic front view of a submerged motor in accordance with a fifth embodiment of the present invention.

### DETAILED DESCRIPTION OF THE PREFERRED EMBODIMENT

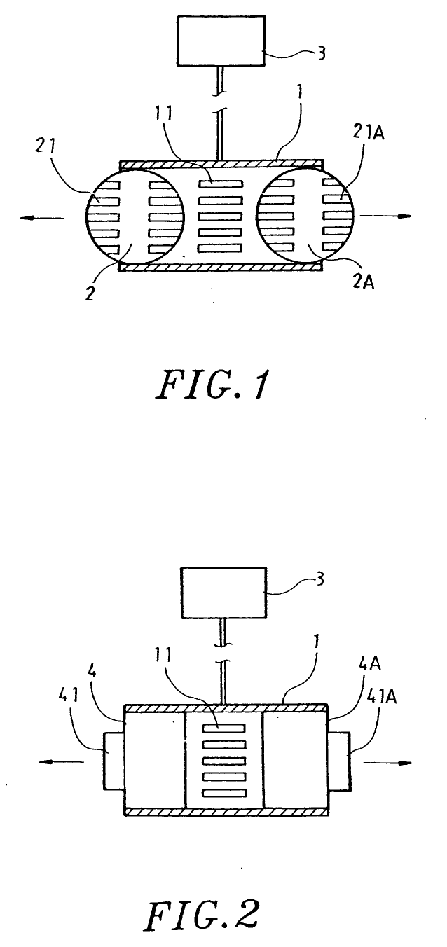

Referring to FIG. 1, a submerged motor in accordance with a first embodiment of the present invention is shown comprising a housing 1, which has a water input port 11 on the middle of the front wall and two water output ports 21 and 21A at the left and right sides of the front wall, a left pump 2 and a right pump 2A respectively mounted in the housing 1 at two opposite lateral sides, and an electric controller 3 electrically connected with the left pump 2 and the right pump 2A and extending out of the housing 1. The electric controller 3 controls the left pump 2 and the right pump 2A to operate alternatively. When the left pump 2 is in operation, the right pump 2A is stopped, and therefore water is pumped into the housing 1 through the water input port 11 and then forced out of the housing 1 through the left-sided water output port 21. On the contrary, when the right pump 2A is in operation, the left pump 2 is stopped, and water is pumped into the housing 1 through the water input port 11 and then forced out of the housing 1 through the right-sided water output port 21A.

Referring to FIG. 2, a submerged motor in accordance with a second embodiment of the present invention is shown comprising a housing 1, which has a water input port 11 on the middle and two water output ports 41 and 41A at the two distal ends, a left pump 4 and a right pump 4A respectively mounted inside the housing 1 at two ends near the water output ports 41 and 41A, and an electric controller 3 electrically connected with the left pump 4 and the right pump 4A and extending out of the housing 1. The electric controller 3 controls the left pump 4 and the right pump 4A to operate alternatively. When the left pump 4 is in operation, the right pump 4A is stopped, and therefore water is pumped into the housing 1 through the water input port 11 and then forced out of the housing 1 through the left-sided water output port 41. On the contrary, when the right pump 4A is in operation, the left pump 4 is stopped, and water is pumped into the housing 1 through the water input port 11 and then forced out of the housing 1 through the right-sided water output port 41A.

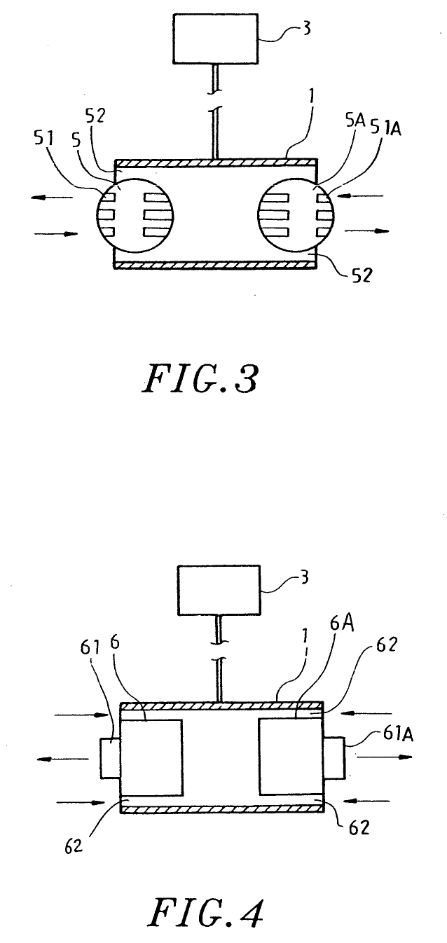

Referring to FIG. 3, a submerged motor in accordance with a third embodiment of the present invention is shown comprising a housing 1, which has two water input ports 51 and 51A respectively disposed on the left and right sides of the front wall and two water output ports 52 respectively disposed at the two distal ends thereof, a left pump 5 and a right pump 5A respectively mounted inside the housing 1 near the two opposite ends of the housing 1, and an electric controller 3 electrically connected with the left pump 5 and the right pump 5A and extending out of the housing 1. The electric controller 3 controls the left pump 5 and the right pump 5A to operate alternatively. When the left pump 5 is in operation, the right pump 5A is stopped, and therefore water is pumped into the housing 1 through the left-sided water input port 51 and then forced out of the housing 1 through the left-sided water output port 52. On the contrary, when the right pump 5A is in operation, the left pump 5 is stopped, and water is pumped into the housing 1 through the right-sided water input port 51A and then forced out of the housing 1 through the right-sided water output port 52.

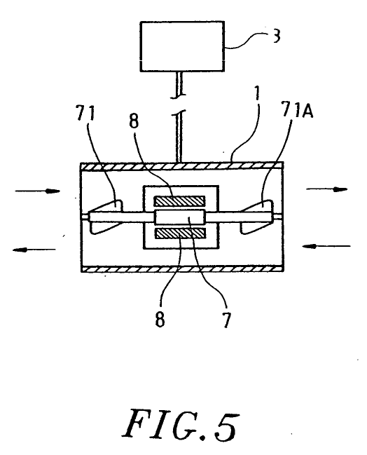

Referring to FIG. 4, a submerged motor in accordance with a fourth embodiment of the present invention is shown comprising a housing 1, which has two water output ports 61 and 61A on the two opposite ends thereof and two water input ports 62 and 62A respectively disposed around the water output ports 61 and 61A, a left pump 6 and a right pump 6A respectively mounted inside the housing 1 near the two opposite ends of the housing 1, and an electric controller 3 electrically connected with the left pump 6 and the right pump 6A and extending out of the housing 1. The electric controller 3 controls the left pump 6 and the right pump 6A to operate alternatively. When the left pump 6 is in operation, the right pump 6A is stopped, and therefore water is pumped into the housing 1 through the right-sided water input port 62 and then forced out of the housing 1 through the left-sided water output port 61. On the contrary, when the right pump 6A is in operation, the left pump 6 is stopped, and water is pumped into the housing 1 through the left-sided water input port 62 and then forced out of the housing 1 through the right-sided water output port 61A.

Referring to FIG. 5, a submerged motor in accordance with a fifth embodiment of the present invention is shown comprising a housing 1, a magnetic rotor 7 horizontally rotatably mounted in the housing 1, two vanes 71 and 71A respectively coupled to the two opposite ends of the magnetic rotor 7, a winding 8 mounted inside the housing 1 around the magnetic rotor 7, and an electric controller 3 electrically connected with the winding 8 and extending out of the housing 1. By means of changing the direction of electric current to the winding 8 subject to the control of the electric controller 3, the direction of rotation of the two vanes 71 and 71A is relatively controlled. When the two vanes two vanes 71 and 71A are rotated clockwise, they pump water through the housing 1 in direction from the right side toward the left side. When the two vanes two vanes 71 and 71A are rotated counter-clockwise, they pump water through the housing 1 in direction from the left side toward the right side.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A submerged motor for use in an aquarium, comprising:
a housing, said housing having at least one water input port and at least one water output port;
a driving mechanism, said driving mechanism comprising a left-sided water pumping means and a right-sided water pumping means for pumping water through said at least one water input port and said at least one water output port in different directions; and
an electric controller electrically connected with said driving mechanism for controlling operation of said left-sided water pumping means and said right-sided water pumping means to change direction and flowing speed of the pumped water.

2. The submerged motor as claimed in claim 1, wherein said left-sided water pumping means and a right-sided water pumping means are water pumps.

3. The submerged motor as claimed in claim 1, wherein said at least one water input port includes two water input ports respectively formed in left and right sides of said housing around said left-sided water pumping means and said right-sided water pumping means.

4. The submerged motor as claimed in claim 1, wherein said driving mechanism further comprises a magnetic rotor rotatably mounted inside said housing, and a winding mounted inside said housing around said magnetic rotor and electrically connected to said electric controller and controllable by said electric controller to cause rotation of said magnetic rotor alternatively in reversed directions; said left-sided water pumping means and said right-sided water pumping means are respectively formed of a respective vane respectively fastened to two opposite ends of said magnetic rotor.
